(19) United States
(12) Patent Application Publication
(10) Pub. No.: US 2026/0118678 A1
(43) Pub. Date: Apr. 30, 2026

(54) INCOUPLER PRISM FOR WAVEGUIDE

(71) Applicant: GOOGLE LLC, Mountain View, CA (US)

(72) Inventors: Alexander Koshelev, San Jose, CA (US); Wei Jin, Saratoga, CA (US); Kang Luo, San Jose, CA (US); Christophe Peroz, Zurich (CH)

(21) Appl. No.: 19/009,088

(22) Filed: Jan. 3, 2025

Related U.S. Application Data
(60) Provisional application No. 63/617,491, filed on Jan. 4, 2024.

(51) Int. Cl. G02B 27/01; G02B 5/04

(52) U.S. Cl. CPC G02B 27/0172; G02B 5/04; G02B 2027/0178

(57) ABSTRACT

An eyewear display includes one or more lenses with an optical combiner integrated therein. The optical combiner includes a waveguide with an incoupler prism that is attached to a first surface of the waveguide. The first surface is opposite to a second surface of the waveguide facing a light emitting image source of the eyewear display. The incoupler prism is configured to receive a display image pupil generated by the light emitting image source and generate two input image pupils for incoupling into the waveguide.

### CROSS-REFERENCE TO RELATED APPLICATIONS

The present application claims priority to U.S. Provisional Application No. 63/617,491, entitled “INCOUPLER PRISM FOR A REFLECTIVE WAVEGUIDE” and filed on Jan. 4, 2024, the entirety of which is incorporated by reference herein.

### BACKGROUND

Eyewear displays employ optical combiners to allow a user to view virtual content (e.g., text, images, or video content) superimposed over the user's environment, creating what is known as augmented reality (AR) or mixed reality (MR). The optical combiner combines light from multiple sources such as environmental light from outside of the eyewear display and display light from a light emitting image source of the eyewear display. The image source, such as a laser projector or a micro-light emitting diode (micro-LED) panel, transmits the display light to the user via a waveguide in the optical combiner. The display light beams from the image source are coupled into the waveguide by an incoupler which can be formed on or disposed within the waveguide. Once the display light beams have been coupled into the waveguide, the incoupled display light beams are “guided” through the waveguide, typically by multiple instances of total internal reflection (TIR), and then directed out of the waveguide by an outcoupler, which can also be formed on or within the waveguide. The outcoupled display light beams overlap at an eye relief distance from the waveguide forming an exit pupil within which a virtual image generated by the image source can be viewed by the user.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 shows an example of an eyewear display in accordance with some embodiments.

FIG. 2 shows an example of a projection system in the eyewear display of FIG. 1, where the projection system includes a waveguide with an incoupler prism attached to a waveguide surface, in accordance with some embodiments.

FIG. 3 shows an example of an incoupler prism that is configured to generate two image input pupils for incoupling into a waveguide from a single display image pupil in accordance with some embodiments.

FIGS. 4 and 5 show examples of an optical adhesive having different optical properties across the interface of the incoupler prism and the waveguide in accordance with some embodiments.

FIG. 6 shows an example of a clocking angle of an incoupler prism in accordance with some embodiments.

FIG. 7 shows examples of techniques for confining the optical adhesive between the interface of the incoupler prism and the waveguide in accordance with some embodiments.

FIG. 8 shows example configurations for positioning the incoupler prism on the waveguide in accordance with some embodiments.

FIG. 9 shows two images illustrating the improvement in the spatial distribution of light attributed to the incoupler prism in accordance with some embodiments.

FIG. 10 shows a diagram illustrating a cause of the pupil replication artifact in reflective waveguides.

FIG. 11 shows a flowchart describing a method for an incoupler prism to generate two copies of an input image pupil for incoupling into a waveguide to reduce the pupil replication artifact in accordance with some embodiments.

### DETAILED DESCRIPTION

Some AR, MR, or virtual reality (VR) eyewear displays employ reflective waveguides to convey an image from the eyewear display's light emitting image source to the user. A reflective waveguide includes a plurality of reflective surfaces (e.g., a series of Louver mirrors) at the outcoupler to outcouple the display light beams from the waveguide. The reflective waveguide can also include other pluralities of reflective surfaces at the incoupler for incoupling light into the waveguide and at the exit pupil expander for expanding the light along one dimension. Reflective waveguides provide high efficiency and color uniformity and minimize the light leakage to the world side of the waveguide. And, unlike diffractive waveguides in which the spectral dispersion causes the input image pupil to expand as it propagates through the waveguide, the beam size in the reflective waveguide stays relatively constant during propagation within the waveguide. However, conventional reflective waveguides are sometimes susceptible to pupil replication artifacts, which are luminance nonuniformity patterns across the eyebox and the field of view (FOV) with a relatively high spatial and angular frequency. The period of these nonuniformity patterns is typically several millimeters (mm) across the eyebox and several degrees across the FOV.

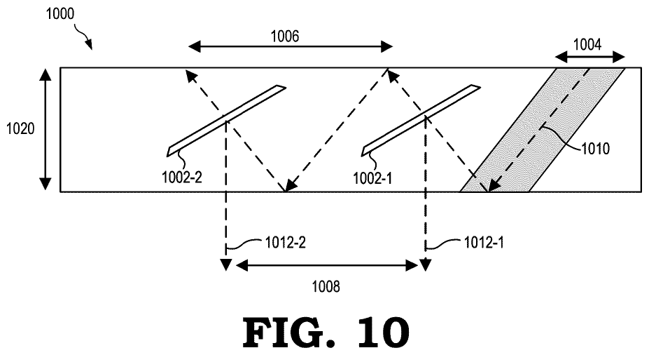

For example, FIG. 10 shows a portion of a reflective waveguide 1000 with a plurality of semitransparent Louver mirrors 1002-1, 1002-2 at the outcoupler illustrating the pupil replication artifact. In the illustrated embodiment, two semitransparent Louver mirrors 1002-1, 1002-2 are depicted, but other embodiments include other numbers of mirrors (e.g., more than two). Each pixel of the image (field angle) to be displayed to the user travels inside the reflective waveguide 1000 as a collimated beam 1010 having a pupil size 1004 (only the pupil size 1004 of the initial beam 1010 is illustrated for clarity purposes). As the beam 1010 propagates through the reflective waveguide 1000, it periodically reflects from the outcoupler's semitransparent Louver mirrors 1002-1, 1002-2, creating output pupil replicas 1012-1, 1012-2 that are outcoupled from the reflective waveguide 1000. The output pupil replicas 1012-1, 1012-2 fill a much larger eyebox size within which the user perceives the image. The beam 1010 also reflects from the surfaces of the waveguide 1000 via TIR bounces, and the spacing between these bounces is referred to as the bounce spacing 1006. The bounce spacing 1006 in the reflective waveguide 1000 is relatively large (e.g., compared to diffractive waveguides) and is in part dependent on the waveguide's thickness 1020, which may range between 1 mm to 4 mm. The pupil size 1004 relative to the bounce spacing 1006 in the reflective waveguide 1000 therefore causes gaps 1008 between the output pupil replicas 1012, which generates the aforementioned spatial nonuniformity pattern referred to as the pupil replication artifact.

To minimize the pupil replication artifact, conventional techniques may include increasing the size of the display image pupil provided by the light engine. However, increasing the size of the display image pupil provided by the light engine leads to other optical aberrations and a much larger size of the light engine itself, which is generally not acceptable within the limited form factor of eyewear displays. Another conventional technique to minimize the pupil replication artifact may be to decrease the thickness of the waveguide, but this presents significant fabrication challenges.

The present disclosure and the accompanying figures present techniques to minimize or eliminate the pupil replication artifact in a reflective waveguide by employing an incoupler prism. The incoupler prism receives a display image pupil from the light engine (e.g., from a light emitting image source and one or more optical components such as lenses, mirrors, prisms, or the like) of the eyewear display and generate two input image pupils for incoupling into the waveguide. That is, the incoupler prism generates two copies of the display image pupil. In this manner, the incoupler prism doubles the input image pupils that are incoupled, propagated through, and eventually outcoupled from the waveguide. This increases the uniformity of the spatial intensity distribution of the outcoupled light, thereby generating a more uniform luminance pattern in the image displayed to the user compared to those generated by conventional reflective waveguides without the incoupler prism.

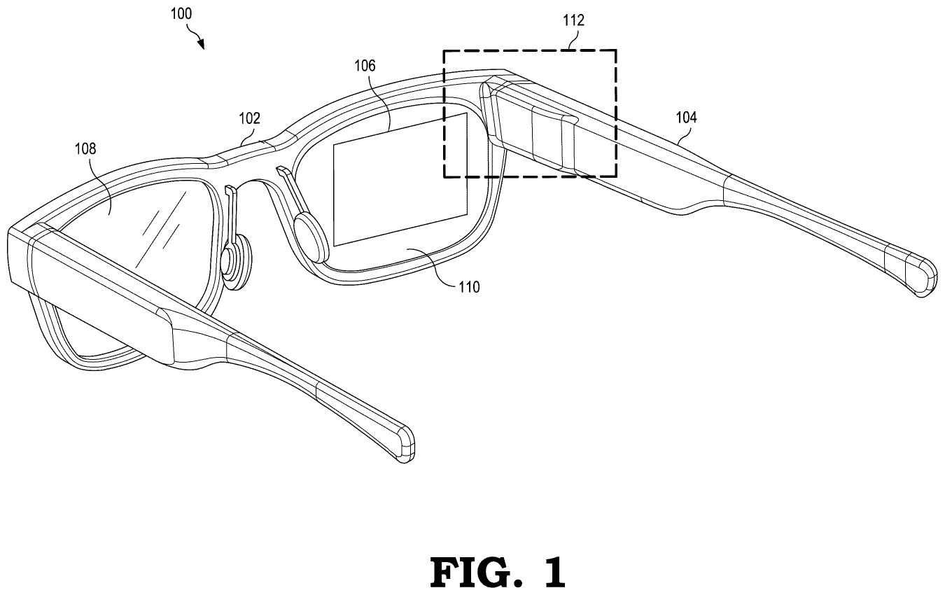

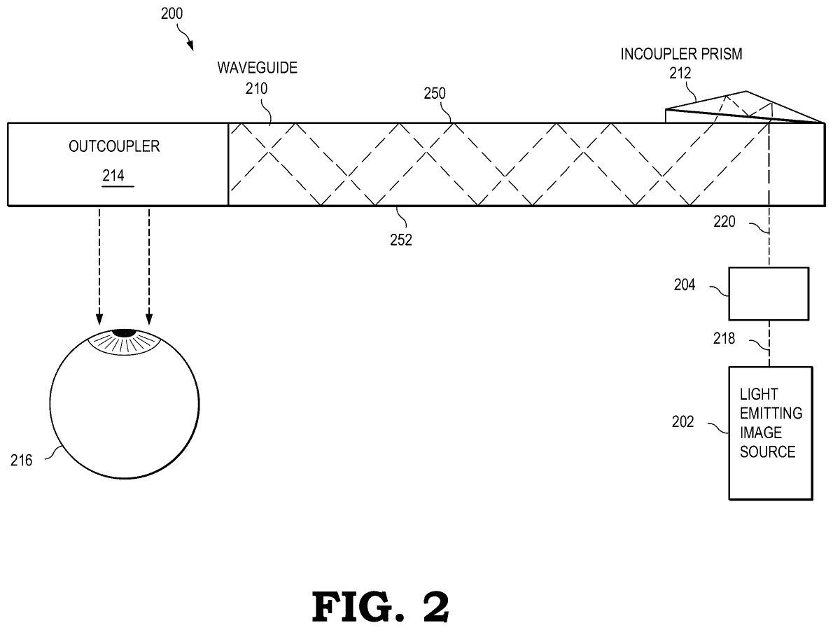

FIG. 1 illustrates an example eyewear display 100 in accordance with various embodiments. The eyewear display 100 (also referred to as a wearable heads up display (WHUD), head-mounted display (HMD), near-eye display, or the like) has a support structure 102 that includes an arm 104, which houses a micro-display projection system configured to project images towards the eye of a user, such that the user perceives the projected images as being displayed in a field of view (FOV) 106 of a display at one or both of lens elements 108, 110. In the depicted embodiment, the support structure 102 of the eyewear display 100 is configured to be worn on the head of a user and has a general shape and appearance (i.e., “form factor”) of an eyeglasses frame. The support structure 102 contains or otherwise includes various components to facilitate the projection of such images towards the eye of the user, such as an image source, a light engine including one or more lenses, prisms, mirrors, or other optical components, and a waveguide (shown in FIG. 2, for example). In some embodiments, the support structure 102 further includes various sensors, such as one or more front-facing cameras, rear-facing cameras, other light sensors, motion sensors, accelerometers, and the like. The support structure 102 further can include one or more radio frequency (RF) interfaces or other wireless interfaces, such as a Bluetooth™ interface, a WiFi interface, and the like. Further, in some embodiments, the support structure 102 includes one or more batteries or other portable power sources for supplying power to the electrical components of the eyewear display 100. In some embodiments, some or all of these components of the eyewear display 100 are fully or partially contained within an inner volume of support structure 102, such as within the arm 104 in region 112 of the support structure 102. It should be noted that while an example form factor is depicted, it will be appreciated that in other embodiments the eyewear display 100 may have a different shape and appearance from the eyeglasses frame depicted in FIG. 1.

In some embodiments, one or both of the lens elements 108, 110 are used by the eyewear display 100 to provide a MR or AR display in which rendered graphical content can be superimposed over or otherwise provided in conjunction with a real-world view as perceived by the user through the lens elements 108, 110. In some embodiments, one or both of lens elements 108, 110 serve as optical combiners that combine environmental light (also referred to as ambient light) from outside of the eyewear display 100 and light emitted from an image source in the eyewear display 100. For example, light used to form a perceptible image or series of images may be projected by the light emitting image source of the eyewear display 100 onto the eye of the user via a series of optical elements, such as a waveguide formed at least partially in the corresponding lens element, a light engine including one or more light filters, lenses, scan mirrors, optical relays, prisms, or the like. In some embodiments, the light emitting image source is configured to emit light having a plurality of wavelength ranges, e.g., red light, green light, and blue light (collectively referred to as RGB light). The light engine propagates the light toward an incoupler of the waveguide. The incoupler of the waveguide receives this light and incouples it into the waveguide. One or both of the lens elements 108, 110 thus includes at least a portion of a waveguide that routes display light received by the incoupler of the waveguide to an outcoupler of the waveguide, which outputs the display light towards an eye of a user of the eyewear display 100. The display light is modulated and projected onto the eye of the user such that the user perceives the display light as an image in FOV 106. In addition, in some embodiments, each of the lens elements 108, 110 is sufficiently transparent to allow a user to see through the lens elements to provide a field of view of the user's real-world environment such that the image appears superimposed over at least a portion of the real-world environment.

In some embodiments, the light emitting image source is a modulative light source such as laser projector or a display panel having one or more light-emitting diodes (LEDs) or organic light-emitting diodes (OLEDs) (e.g., a micro-LED display panel or the like) located in region 112. In some embodiments, the image source is configured to emit RGB light. The image source is communicatively coupled to the controller (not shown) and a non-transitory processor-readable storage medium or memory storing processor-executable instructions and other data that, when executed by the controller, cause the controller to control the operation of the image source. In some embodiments, the controller controls a display area size and display area location for the image source and is communicatively coupled to the image source that generates virtual content to be displayed at the eyewear display 100. In some embodiments, the image source emits light over a variable area, designated the FOV 106, of the eyewear display 100. The variable area corresponds to the size of the FOV 106, and the variable area location corresponds to a region of one of the lens elements 108, 110 at which the FOV 106 is visible to the user. Generally, it is desirable for a display to have a wide FOV 106 to accommodate the outcoupling of light across a wide range of angles.

As previously mentioned, a waveguide (e.g., such as a reflective waveguide) is integrated into one or both of lens elements 108, 110. In some configurations, the waveguide includes a single waveguide substrate and in other configurations, the waveguide includes multiple waveguide substrates stacked on top of one another (referred to as a waveguide stack). As previously discussed, the waveguide's size and shape (collectively referred to as the “form factor” of the waveguide) is restricted by the shape and volume of the lens elements 108, 110. The restriction of the waveguide's form factor restricts the positioning and the areas of the incoupler, exit pupil expander, and the outcoupler (not shown in FIG. 1) of the waveguide. Moreover, the limited form factor can also impact the quality of the image displayed to the user of the eyewear display. For example, eyewear displays that employ conventional reflective waveguides can be susceptible to nonuniform luminance patterns in the image displayed to the user. The techniques presented herein provide a compact incoupler prism that increase the uniformity of the luminance of the image displayed via the FOV area 106 while fitting within the limited form factor of the eyewear display 100.

FIG. 2 illustrates an example of a projection system 200 that projects images onto an eye 216 of a user in accordance with various embodiments. The projection system 200, which may be implemented in the eyewear display 100 in FIG. 1, includes one or more of a light emitting image source 202, projection optics 204 (also referred to as the light engine or the light engine assembly), and a waveguide 210. In some embodiments, the projection optics 204 include lenses, prisms, mirrors, or other optical components for receiving the display light 218 emitted from the light emitting image source 202, shaping the light, and outputting a display image pupil 220 to the waveguide 210. The waveguide 210 includes an incoupler prism 212 and an outcoupler 214, with the outcoupler 214 being optically aligned with an eye 216 of a user. For example, the outcoupler 214 substantially overlaps or corresponds with the FOV 106 shown in FIG. 1. For purposes of clarity, FIG. 2 illustrates the projection system 200 with respect to propagating display light from the light emitting image source 202 to one eye 216 of the user. In some embodiments, the projection system 200 includes a similar configuration to propagate display light 218 from the light emitting image source 202 to a second eye of the user (not shown in FIG. 2).

In some embodiments, the image source 202 (such as a micro-LED display or a laser projector) includes one or more light sources configured to generate and project display light 218 (e.g., visible light such as red, blue, and green light and, in some embodiments, non-visible light such as infrared light). In some embodiments, the image source 202 is coupled to a driver or other controller (not shown), which controls the timing of emission of display light from the light sources of the image source 202 in accordance with instructions received by the controller or driver from a computer processor coupled thereto to modulate the display light 218 to be perceived as images when output to the retina of an eye 216 of a user. For example, during operation of the projection system 200, one or more beams of display light 218 are output by the light source(s) of the image source 202 and then directed into the waveguide 210 before being directed to the eye 216 of the user. The image source 202 modulates the respective intensities of the light beams so that the combined light reflects a series of pixels of an image, with the particular intensity of each light beam at any given point in time contributing to the amount of corresponding color content and brightness in the pixel being represented by the combined light at that time.

In some embodiments, the image source 202 projects the display light 218 to projection optics 204. The projection optics 204 include mirrors (such as micro-electromechanical system (MEMS) mirrors), lenses, prisms, or the like, to receive the display light 218 emitted from the light emitting image source 202 and introduce convergence of the light 218 in a first dimension to an exit pupil beyond the projection optics 204. Herein, an “exit pupil” in an optical system refers to the location along the optical path where beams of light intersect. Accordingly, the exit pupil can be considered a “virtual aperture.” According to various embodiments, the projection optics 204 includes one or more collimation lenses that shape and focus the light 218 or includes a molded reflective relay that includes two or more spherical, aspheric, parabolic, and/or freeform lenses that shape and direct a display image pupil 220 toward the waveguide 210.

As illustrated in FIG. 2, the waveguide 210 of the projection system 200 includes the incoupler prism 212 and the outcoupler 214. In some embodiments, the waveguide 210 also includes an exit pupil expander, which is not shown in FIG. 2 for clarity purposes but is positioned in the optical path between the incoupler prism 212 and the outcoupler 214. The term “waveguide,” as used herein, will be understood to mean a combiner using one or more of total internal reflection (TIR), specialized filters, or reflective surfaces, to transfer light from an incoupler (such as the incoupler prism 212) to an outcoupler (such as the outcoupler 214). In some display applications, the light is a collimated image, and the waveguide 210 transfers and replicates the collimated image to the eye. In general, the terms “incoupler,” “exit pupil expander,” and “outcoupler” will be understood to refer to any type of optical grating structure or prism, including, but not limited to, reflective surfaces (including partially reflective surfaces) such as Louver mirrors, diffraction gratings, holograms, holographic optical elements (e.g., optical elements using one or more holograms), volume diffraction gratings, volume holograms, surface relief diffraction gratings, and/or surface relief holograms.

In some embodiments, a given incoupler, exit pupil expander, or outcoupler is configured as a transmissive grating or series of transmissive surfaces (e.g., a series of transmissive surfaces, a transmissive diffraction grating, or a transmissive holographic grating) that causes the incoupler, exit pupil expander, or outcoupler to transmit light and to apply designed optical function(s) to the light during the transmission. In some embodiments, a given incoupler, exit pupil expander, or outcoupler is a reflective grating or series of reflective surfaces (e.g., a series of partially reflective mirrors, a reflective diffraction grating, or a reflective holographic grating) that causes the incoupler, exit pupil expander, or outcoupler to reflect light and to apply designed optical function(s) to the light during the reflection. For example, each one of the exit pupil expander, and/or the outcoupler includes a respective set of partially reflective mirror facets with the same or with different reflection to transmission ratios. In some embodiments, the incoupler is an incoupler prism 212 with a plurality of surfaces to create two input image pupils based on the display input pupil 220 received from the projection optics 204 in order to increase the number of input image pupils that are incoupled into and propagated through the waveguide 220.

The incoupler prism 212 is configured to receive the display image pupil 220 from the projection optics 204 through the waveguide 210 and incouple the display image pupil 220 for propagation into the waveguide 210. In addition, the incoupler prism 212 is configured to generate a replica of the display image pupil 220 so that two copies of the display image pupil 220 are propagated through the waveguide 210. This increases the density of the light that is outcoupled toward the eye 216 of the user, which reduces or eliminates the pupil replication artifact associated with the waveguide 214. In some embodiments, the incoupler prism 212 is defined by a smaller dimension (i.e., width) and a larger orthogonal dimension (i.e., length) with a first edge that is in the optical path toward the outcoupler 214 and a second edge that is on the opposite side of the optical path toward the outcoupler 214. In some embodiments, the “incoupler region” is defined as the region of the waveguide 210 between the first edge and the second edge. Similarly, the “outcoupler region” is defined as the region of the waveguide occupied by the outcoupler 214. In the present example, the display image pupil 220 received at the incoupler 212 is relayed to the outcoupler 214 via the waveguide 210 using TIR. A portion of the display image pupil 220 is then output to the eye 216 of a user via the outcoupler 214. Also, in some embodiments, an exit pupil expander (not shown in FIG. 2), such as a fold or other optical grating or surface, is arranged in an intermediate stage between incoupler 212 and outcoupler 214 to receive light that is coupled into waveguide 210 by the incoupler 212, expand the light in at least one dimension, and redirect the light towards the outcoupler 214, where the outcoupler 214 then couples the light out of waveguide 210. In some embodiments, the exit pupil expander and the outcoupler 214 are integrated into a common component. As described above, in some embodiments the waveguide 210 is implemented in an optical combiner as part of a lens, such as one of the lens elements 108, 110 of FIG. 1.

The waveguide 210 further includes two major surfaces 250 and 252, with major surface 250 being world-side (i.e., the surface farthest from the user) and major surface 252 being eye-side (i.e., the surface closest to the user). In some embodiments, the waveguide 210 is positioned between a world-side lens and an eye-side lens, which form lens elements 108, 110 shown in FIG. 1, for example. In some embodiments, the incoupler prism 212 is located at the major surface 250 and the light emitting source 202 is located at the other major surface 252.

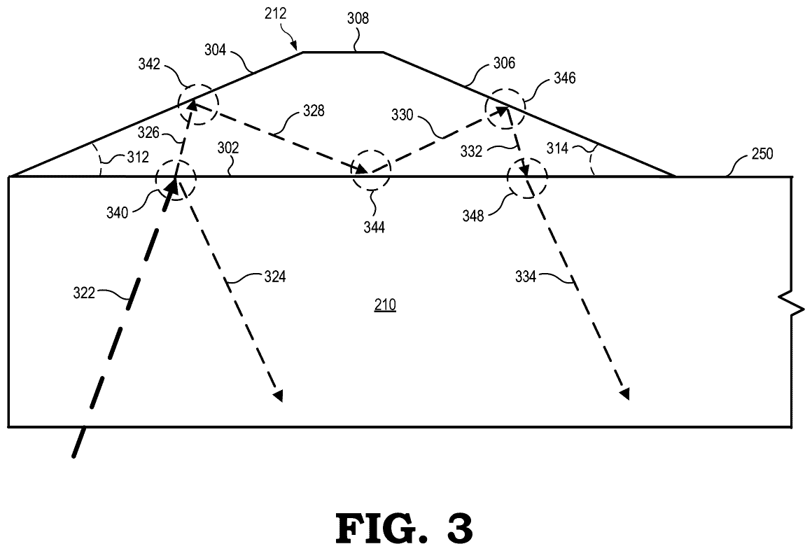

FIG. 3 shows an example of the incoupler prism 212 that is configured to be attached to a waveguide 210 in accordance with some embodiments. The waveguide 210, in some embodiments, is a reflective waveguide with an outcoupler (not shown) that includes a set of partially reflective mirrors or facets.

The incoupler prism 212 includes a first surface 302 that is configured to be attached to the major surface 250 waveguide 210, a second surface 304, and a third surface 306. The second surface 304 and the third surface 306, in some embodiments, are mirror coated. In some embodiments, the second surface 304 and the third surface 306 have a reflectivity of at least 85%. The first surface 302 includes a semi-transparent mirror coating such as a multilayer dielectric mirror. In some embodiments, the first surface 302 reflects approximately 30% to 50% of light for near-normal incidence angles (e.g., at the reflection 340). In some embodiments, a first prism angle 312, between the first surface 302 and the second surface 304, and a second prism angle 314, between the first surface 302 and the third surface 306, are identical or nearly identical such that the difference between the first prism angle 312 and the second prism angle 314 is less than 0.01°. In some embodiments, the first prism angle 312 and the second prism angle 314 are less than 45°, e.g., between 25° and 35°.

In the illustrated embodiment, the incoupler prism 212 includes a fourth surface 308 opposite and parallel to the first surface 302, but in other embodiments, the incoupler prism 212 does not include the fourth surface 308, i.e., the second surface 304 and the third surface 306 touch and form a vertex opposite to the first surface 302. As such, in some cases, the incoupler prism 212 is an isosceles triangular prism (if the fourth surface 308 is absent), or, as demonstrated in the illustrated embodiment, in other cases, the incoupler prism 212 is an isosceles trapezoidal prism.

The incoupler prism 212 is configured to receive an initial ray 322 that is emitted from the light emitting image source through the projection optics and the waveguide. The initial ray 322 is, for example, the display image pupil 220 (also referred to herein as a light engine pupil) after the display image pupil 220 initially enters the waveguide 210 from the projection optics 204 of FIG. 2. The initial ray 322 is incident on the incoupler prism at a first reflection point 340. At reflection point 340, a first portion 324 of the ray power of the initial ray 322 is reflected from the first surface 302 and is incoupled in the waveguide 210. The remainder (i.e., a second portion 326) of the ray power passes through the first surface 302 into the incoupler prism 212 and reflects from the second surface 304 at reflection point 342. After reflecting from the second surface 304 at reflection point 342, the second portion 328 travels through the incoupler prism 212 and reflects off of the first surface 302 at reflection point 344. After reflecting from the first surface 302 at reflection point 344, the second portion 330 travels through the incoupler prism and reflects from the third surface 306 at reflection point 346, which redirects the second portion 332 toward the first surface 302. At point 348, the second portion 332 is near-normal to the first surface 302 and passes through the first surface 302 so that it is incoupled into the waveguide 212 as second portion 334. The second portion 334 that is incoupled into the waveguide 212 is parallel or nearly parallel (e.g., within 0.1° or less) to the first portion 324. Thus, the incoupler prism 212 is configured to generate and incouple two rays of light (i.e., the first portion 324 and the second portion 334) based on a single ray of light incident thereon (i.e., the initial ray 322). In this manner, the incoupler prism 212 increases the light density of the luminance pattern in the image displayed over the FOV area of an eyewear display, thereby improving the quality of the image delivered to the user of the eyewear display.

Since the incoupler prism 212 is an isosceles prism (in the illustrated embodiment, the incoupler prism 212 is an isosceles trapezoidal prism, but in other embodiments, the incoupler prism 212 is an isosceles triangular prism), the second portion 334 of incoupled light is parallel to the first portion 324 of incoupled light. In some embodiments, the angle between the first portion 324 and the second portion 334 is 2*RI*Δα, where RI is the refractive index of the incoupler prism 212 and Δα is the difference between the first prism angle 312 and the second prism angle 314.

Thus, the incoupler prism 212 is configured to split the display image pupil, or the initial ray 322, that is initially incident on the incoupler prism 212 into two (near) identical input image pupils corresponding to first portion 324 and second portion 334. And, due to the isosceles feature of the incoupler prism 212, the image carried by the input image pupils corresponding to the first portion 324 and the second portion 334 substantially or completely overlaps in the angular domain. In some embodiments, in cases where the incoupler prism 212 is an isosceles trapezoidal prism, the fourth surface 308 is parallel to the first surface 302 and is coated with an anti-reflective coating to avoid the generation of image ghosts.

In some embodiments, to minimize light loss within the incoupler prism 212, the incoupler prism 212 is designed to maximize the reflection at reflection point 344. In some cases, the refractive index of the incoupler prism 212 compared to the surrounding medium is high enough to satisfy TIR conditions, thereby ensuring no light loss at reflection points 342, 344, 346.

As illustrated in FIG. 2, the incoupler prism 212 is attached to the backside surface of the waveguide 220 relative to the surface of the waveguide that faces the light emitting image source 202. That is, the light engine (including the projection optics 204) is positioned on the opposite side of the waveguide 210 relative to the incoupler prism 212 and transmits the initial ray 322 of light toward the incoupler prism 212 through the waveguide 210. In some embodiments, the incoupler prism 212 is bonded to the surface 250 of the waveguide 210 with a pre-determined slope angle in order to ensure that the light reflected from the incoupler prism 212 is coupled into the waveguide 210 at a TIR angle. The incoupler prism 212, in some embodiments, is attached to the waveguide 210 with a transparent optical adhesive. The refractive index of the optical adhesive is low enough to ensure that the TIR (or the near-TIR condition) is fulfilled during the reflection at reflection point 344. In some embodiments, the refractive index of the incoupler prism 212 is at least 40% higher than the refractive index of the transparent optical adhesive, i.e., RIₚᵣᵢₛₘ/RI_{adhesive}>1.40. For example, if the refractive index of the incoupler prism is 1.8, the refractive index of optical adhesive that attaches the incoupler prism 212 to the waveguide 210 is 1.3 or lower.

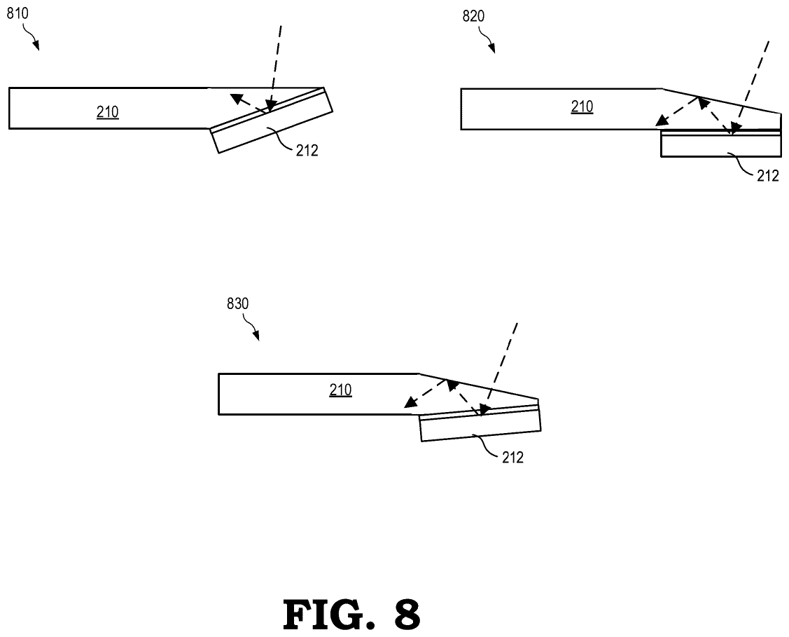

In some embodiments, the sloped surface of the waveguide 210 (e.g., illustrated in more detail in FIG. 8) on which the incoupler prism 212 is positioned is coated with an antireflective (AR) coating to minimize the reflection from the waveguide/adhesive interface so that initial ray 322 reflects from the first surface 302 of the incoupler prism 212 and not from the surface 250 of the waveguide 210. This eliminates the possibility of a double image in case the adhesive layer attaching the incoupler prism 212 to the waveguide 210 contains a wedge or other variation in thickness. The presence of the adhesive layer, as opposed to air, reduces the refractive index difference at the AR coated interface, thereby facilitating the coating design of the waveguide 210. If the refractive index of the adhesive is close to that of the material used for the waveguide 210 (e.g., within 0.1), then no additional coating is needed to ensure less than 1% reflection. In some embodiments, the adhesive used to attach the incoupler prism 212 to the waveguide 210 is tuned to have different optical properties across the interface between the incoupler prism 212 to the waveguide 210 to improve the uniformity between the first portion 324 and the second portion 334.

In some embodiments, the first surface 302 of the incoupler prism 212 is coated with a low refractive index material with a refractive index about 1.3 or less. The low refractive index material ensures that the reflection at reflection point 344 occurs under the TIR condition. Thus, in this case, the optical adhesive used to attach the incoupler prism 212 to the waveguide 210 may not need to be a low refractive index glue. In some embodiments, the low refractive index at the first surface 302 is achieved by used a patterned metasurface at the first surface 302. In other embodiments, the low refractive index at the first surface 302 is achieved by using a multilayer dielectric coating.

In some embodiments, the incoupler prism 212 is adhered to the waveguide 210 only on the sides, thereby leaving an air gap between the first surface 302 of the incoupler prism 212 and the surface 250 of the waveguide 210. This enables the use of a low refractive index prism and any adhesive material since RIₚᵣᵢₛₘ/RIₐᵢᵣ>1.40 for most glass or polymer materials.

In another embodiment, the waveguide 210 includes a sloped surface on which the incoupler prism 212 is positioned (e.g., as shown in diagram 810 of FIG. 8). A semitransparent coating is applied to the sloped surface, and an AR coating is applied to the first surface 302 of the incoupler prism 212. In this case, the prism angles 312, 314 that need to be (near) identical are calculated with respect to the sloped surface of the waveguide 210 instead of the first surface 302. To achieve this, an active alignment approach between the incoupler prism 212 and the waveguide 210 can be used to achieve precise control of the air gap or the adhesive layer between the incoupler prism 212 and the waveguide 210.

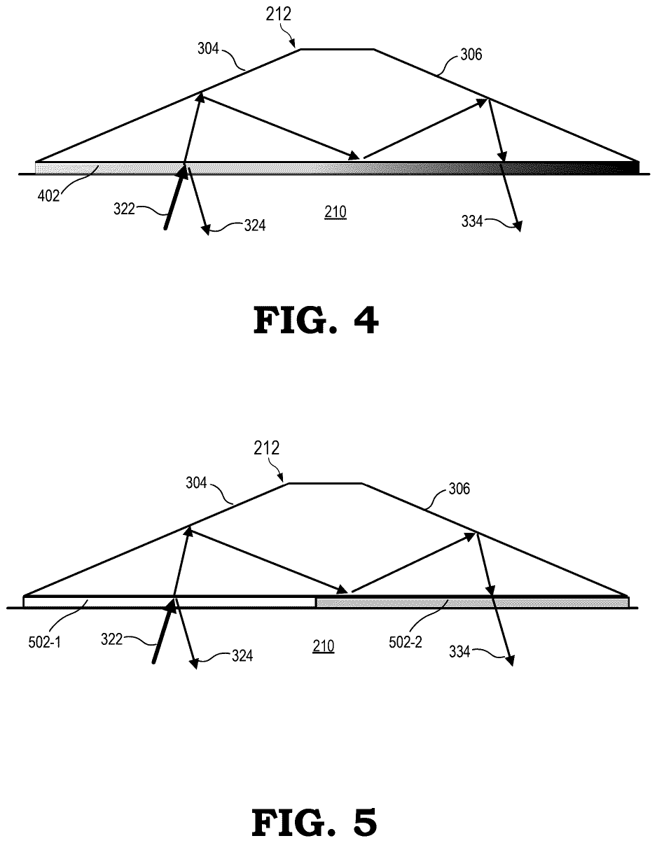

FIGS. 4 and 5 show examples of an optical adhesive having different optical properties across the interface between the incoupler prism 212 and the waveguide 210 in accordance with some embodiments.

In FIG. 4, the optical adhesive layer 402 has a gradient profile across the interface between the incoupler prism 212 and the waveguide 210, and in FIG. 5, the optical adhesive layer 502 has a plurality of zones 502-1, 502-2. The optical properties in the interface between the incoupler prism 212 and the waveguide 210 are selected based on the desired optical functions for that particular region and to improve the uniformity and the intensity of the light between the first portion 324 and the second portion 334 that is incoupled into the waveguide 210. In some embodiments, the optical adhesive layer 402 of FIG. 4 and the optical adhesive layer 502 of FIG. 5 is locally dispensed by jet dispensing, slot die coating, or the like. In some embodiments, different additives such as die or light absorption components are added to the optical adhesive to achieve the desired gradient illustrated in FIG. 4 or the different zones illustrated in FIG. 5.

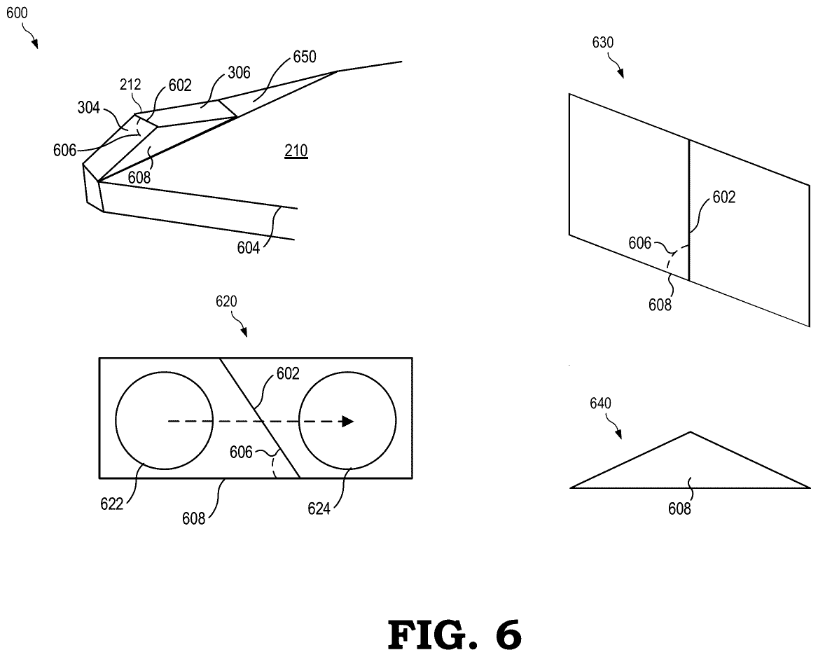

FIG. 6 shows an example of the incoupler prism 212 being positioned at a clocking angle 606 with respect to the waveguide 210 in accordance with some embodiments. Diagram 600 shows a first view of the clocked angle configuration, and diagram 620 shows a top view of the configuration illustrated in diagram 600 focusing on the top edge 602 of the incoupler prism 212. In addition, FIG. 6 shows the incoupler prism 212 being positioned on a sloped surface 650 of the waveguide 210.

In the illustrated embodiment, the incoupler prism 212 is an isosceles triangular prism with a top edge 602 that joins the second surface 304 and the third surface 306 opposite to the first surface (i.e., the bottom surface corresponding to the first surface 302 as described in FIG. 3) of the incoupler prism 212 that faces the waveguide 210. The incoupler prism 212 is positioned at a clocking angle 606 with respect to an edge 602 of the incoupler prism 212. That is, the top edge 602 is not orthogonal to the fourth surface 608 of the incoupler prism 212. The clocking angle 606 controls the direction of the light after reflection from the first surface 304 (e.g., corresponding to the reflection point 342 of FIG. 3). In the illustrated embodiment, the clocking angle 606 is about 55° as opposed to 90° as it would be for a non-clocked configuration. Positioning the incoupler prism 212 at the clocking angle 606 prevents the clipping of the image input pupil upon reflecting from the third surface 306 of the incoupler prism 212.

That is, the clocking angle 606 ensures that the light that is propagated within the incoupler prism 212 and eventually incoupled to the waveguide 210 as the second portion (e.g., the second portion 334) is not clipped at an edge of the incoupler prism 212. For example, diagram 620 shows the image input pupil 622 that internally reflects from the second surface 304 of incoupler prism 212 (i.e., this corresponds to the reflection at reflection point 342 of FIG. 3) and the image input pupil 624 that internally reflects from the third surface 306 of the incoupler prism 212 (i.e., this corresponds to the reflection at reflection point 346 of FIG. 3). As illustrated, there is no clipping in either one of the image input pupils 622, 624. This increases the amount of light and the quality of the image that is eventually outcoupled by the waveguide 210 to the user. Diagram 630 illustrates an additional top view of the incoupler prism 212 showing the top edge 602 positioned at the clocking angle 606 with respect to the fourth surface 608 of the incoupler prism 212, and diagram 640 shows a side view of the fourth surface 608 of the incoupler prism 212.

In some embodiments, the clocking angle 606 is selected based on the slope angle of the sloped surface 650. The clocking angle 606 can therefore be selected to optimize the offset between the two input image pupils coupled into the waveguide 210 in order to minimize the gaps between the two input image pupils.

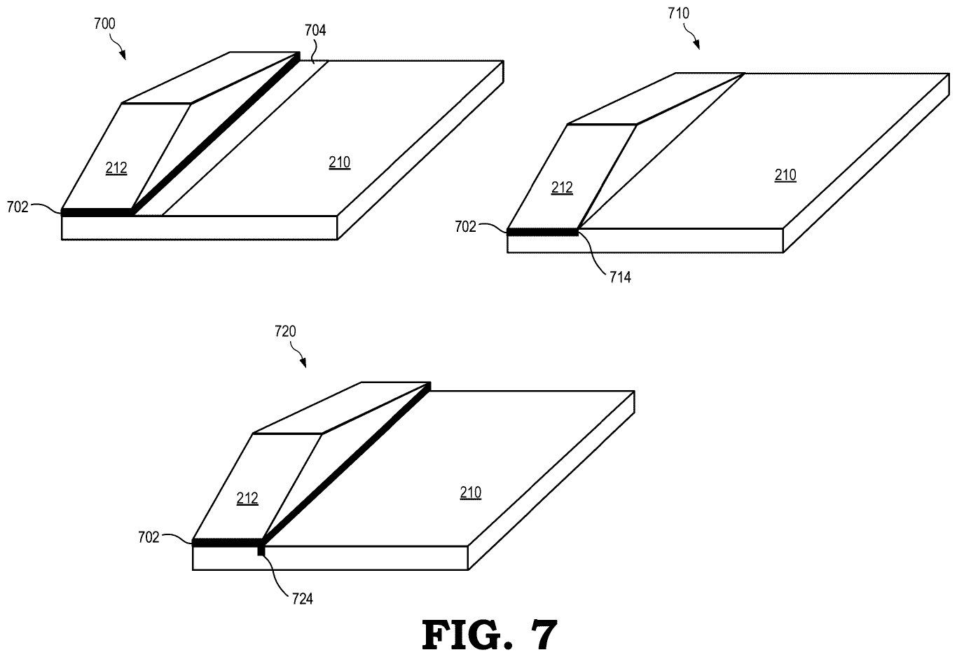

FIG. 7 shows examples of three configurations 700, 710, 720 for confining the optical adhesive 702 between the incoupler prism 212 and the waveguide 210 in accordance with some embodiments. Configuration 700 includes a thin, hydrophobic layer 704 on the waveguide surface adjacent to the incoupler prism. The hydrophobic layer 704 prevents the optical adhesive 702 from spilling over and spreading onto the surface of the waveguide 210. Configuration 710 includes a step 714 in the waveguide 210 at the boundary between the incoupler prism 212 and the waveguide 210 to maintain the optical adhesive 702 below the incoupler prism 212. Configuration 720 includes a trench 724 in the waveguide 210 at the boundary under the incoupler prism 212 to maintain the optical adhesive 702 below the incoupler prism 212. In this manner, the configurations 700, 710, 720 provide examples for maintaining the optical adhesive 702 in the interface between the incoupler prism 212 and the waveguide 210 so as to prevent the optical adhesive 702 from spilling onto the waveguide 210 and degrading the optical performance of the waveguide 210.

FIG. 8 shows example configurations 810, 820, 830 for positioning the incoupler prism 212 on the waveguide 210 in accordance with some embodiments. In the illustrated embodiments, the shape of the waveguide 210 is designed so that incoupled light from the incoupler prism 212 satisfies TIR conditions for propagating within the waveguide 210. For example, in diagram 810, the waveguide 210 includes a sloped surface on which the incoupler prism is positioned. In diagrams 820, 830, the waveguide 210 includes a sloped surface opposite to the surface of the incoupler prism 212.

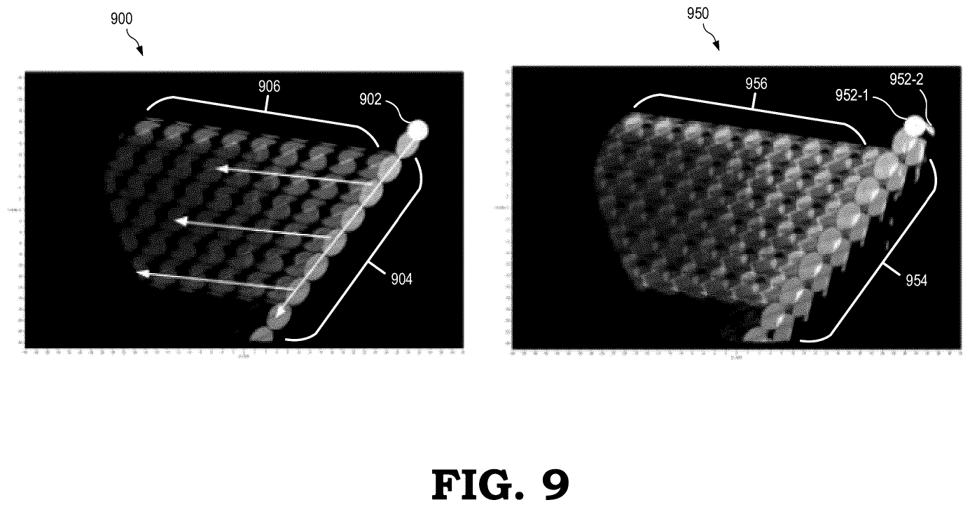

FIG. 9 shows the effect that the incoupler prism has on the spatial distribution of light from the light engine as it propagates through the waveguide.

The left diagram 900 shows the spatial distribution of a conventional waveguide without the incoupler prism. As shown, the left diagram 900 has a single input pupil 902 that is incoupled by the waveguide. The single input pupil is then expanded along a first dimension by the exit pupil expander in the region 904, and then expanded in a second dimension and outcoupled out of the waveguide by the outcoupler in the region 906. As illustrated in diagram 900, there are significant gaps in the spatial intensity distribution of the light that is outcoupled in the region 906.

The right diagram 950 shows the spatial distribution of a waveguide including the incoupler prism of the present disclosure. In the right diagram, there are two input pupils 952-1, 952-2 that are incoupled into the waveguide by the incoupler prism. This in effect doubles the input pupils that are propagated through the waveguide, thereby doubling the amount of light that is outcoupled by the waveguide in the region 956. As illustrated, the spatial intensity distribution of light in the region 956 has better uniformity and less pupil replication artifacts than the region 906 of the left diagram 900.

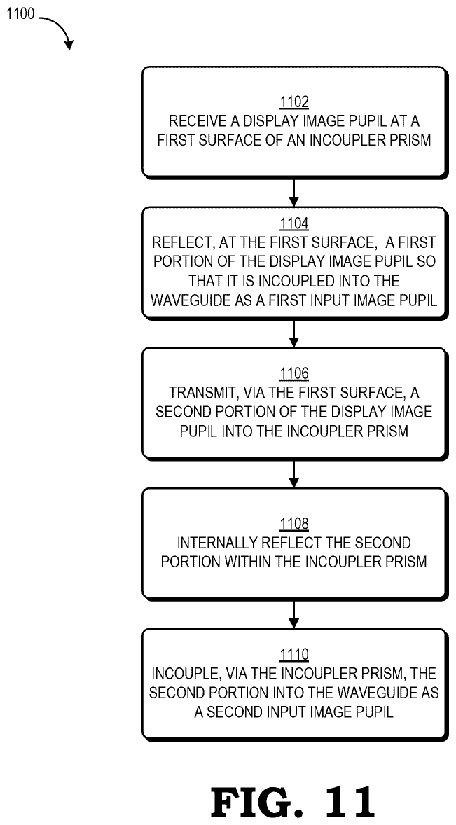

FIG. 11 shows a flowchart 1100 describing a method for an incoupler prism to incouple two image input pupils into a waveguide from a single display image pupil in accordance with some embodiments. For example, the incoupler prism corresponds to the incoupler prism 212 and the waveguide corresponds to the waveguide 210 described in any one of the preceding figures.

At block 1102, the method includes the incoupler prism receiving a display image pupil (corresponding to the initial ray 322 of FIG. 3) at a first surface (corresponding to the first surface 302 of FIG. 3).

At block 1104, the method includes reflecting, at the first surface, a first portion of the display image pupil so that the first portion is incoupled into the waveguide as a first input image pupil (e.g., corresponding to the first potion 324 of FIG. 3).

At block 1106, the method includes transmitting, via the first surface, a second portion (e.g., corresponding to the second portion 326 of FIG. 3) of the display image pupil into the incoupler prism.

At block 1108, the method includes internally reflecting the second portion within the incoupler prism (e.g., corresponding to the optical path of light following the reference numbers 326-342-328-344-330-346-332 of FIG. 3).

At block 1110, the method includes incoupling, via the incoupler prism, the second portion into the waveguide as a second input image pupil (corresponding to the second portion 334 of FIG. 3).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A device comprising:
a waveguide comprising a first side opposite to a second side, wherein the second side faces a light emitting source configured to emit display light forming a display image pupil; and
an incoupler prism configured to be attached to the first side, the incoupler prism configured to receive the display image pupil and generate two input image pupils for incoupling into the waveguide.

2. The device of claim 1, wherein the incoupler prism comprises:
a first surface configured to be attached to the first side of the waveguide.

3. The device of claim 2, wherein the first surface is to reflect a first portion of a light incident thereon in a first direction as a first input image pupil of the two input image pupils and transmit a second portion of the light incident thereon in a second direction into the incoupler prism.

4. The device of claim 3, wherein the incoupler prism comprises:
a second surface to receive the second portion transmitted in the second direction and reflect the second portion in a third direction toward the first surface, wherein the first surface receives the second portion reflected in the third direction and reflects the second portion in a fourth direction.

5. The device of claim 4, wherein the incoupler prism comprises:
a third surface to receive the second portion of light reflected in the fourth direction and reflect the second portion of light in a fifth direction to be transmitted through the first surface as a second input image pupil of the two input image pupils.

6. The device of claim 5, wherein the second surface is positioned at a first prism angle to the first surface, wherein the third surface is positioned at a second prism angle to the first surface.

7. The device of claim 6, wherein the first prism angle and the second prism angle differ from each other by less than about 0.01°.

8. The device of claim 5, wherein the second surface and the third surface are reflective surfaces with a reflectivity of at least approximately 85% within a visible range of light.

9. The device of claim 5, wherein the first surface is a semi-transparent surface.

10. The device of claim 5, wherein the first surface comprises a semi-transparent mirror coating or multilayer dielectric coating having a reflectivity between approximately 30% and 50% within a visible range of light.

11. The device of claim 1, wherein the incoupler prism is attached to the waveguide with an optical adhesive layer positioned between the incoupler prism and the first side of the waveguide.

12. The device of claim 11, wherein the optical adhesive layer includes an optical property that changes across an interface between the incoupler prism and the first side of the waveguide, and wherein the optical property is a refractive index of the optical adhesive layer.

13. The device of claim 1, wherein the first side of the waveguide comprises an antireflective coating for light within a visible range of light.

14. The device of claim 1, further comprising a hydrophobic coating on the first side of the waveguide immediately adjacent to the incoupler prism.

15. The device of claim 11, further comprising a trench in the first side of the waveguide under an edge of the incoupler prism.

16. The device of claim 11, further comprising a step on the first side of the waveguide at a boundary adjacent to the incoupler prism.

17. The device of claim 1, wherein the incoupler prism is positioned at a clocking angle on the first side of the waveguide.

18. The device of claim 17, wherein the clocking angle is non-orthogonal relative to an edge of the waveguide.

19. A method comprising:
emitting, from a light emitting image source facing a first side of a waveguide, display light forming a display image pupil;
receiving, via an incoupler prism attached to a second side of the waveguide opposite to the first side, the display image pupil; and
generating, via the incoupler prism, two input image pupils for incoupling into the waveguide from the display image pupil.

20. An incoupler prism comprising:
a first surface configured to be attached to a first side of a waveguide, wherein the first surface is to reflect a first portion of a light incident thereon in a first direction as a first input image pupil of the two input image pupils and transmit a second portion of the light incident thereon in a second direction;
a second surface to receive the second portion transmitted in the second direction and reflect the second portion in a third direction toward the first surface, wherein the first surface receives the second portion reflected in the third direction and reflects the second portion in a fourth direction; and
a third surface to receive the second portion of light reflected in the fourth direction and reflect the second portion of light in a fifth direction to be transmitted through the first surface as a second input image pupil of the two input image pupils.
